(19) United States
(12) Patent Application Publication
(10) Pub. No.: US 2017/0102786 A1
(43) Pub. Date: Apr. 13, 2017

(54) METHOD AND DEVICE FOR PROVIDING AN ALERT

(71) Applicant: LENOVO (BEIJING) LIMITED, BEIJING (CN)

(72) Inventor: BEN XU, BEIJING (CN)

(21) Appl. No.: 15/000,759

(22) Filed: Jan. 19, 2016

(30) Foreign Application Priority Data
Oct. 10, 2015 (CN) 201510651448.4

(51) Int. Cl. G06F 3/0338; G04F 1/00; G06F 1/14; G06F 3/0484; G05B 15/02; G06F 1/16

(52) U.S. Cl. CPC G06F 3/0338; G05B 15/02; G06F 1/1652; G06F 1/14; G06F 3/04847; G04F 1/00

(57) ABSTRACT

One embodiment provides a method, including: determining a first bending angle of a flexible body of an electronic device; deriving a timing duration in accordance with the first bending angle of the flexible body; controlling the first bending angle of the flexible body until the first bending angle of the flexible body gradually becomes a target bending angle at the end of the timing duration; and providing an alert upon the first bending angle of the flexible body becoming the target bending angle at the end of the timing duration. Other aspects are described and claimed.

### CLAIM FOR PRIORITY

This application claims priority to Chinese Application No. 201510651448.4, filed on Oct. 10, 2015, which is fully incorporated by reference herein.

### FIELD

The subject matter described herein relates to the technical field of information processing, and more particularly, relates to a reminding control method and device.

### BACKGROUND

In daily life, a user can use the clock setting function of electronic devices, such as a mobile phone and a tablet PC, to set an alarm or timer. If a time duration or time as set by the user is reached, the electronic device can sound an alarm to alert the user. In practice, however, if the user wishes to know a remaining time duration to the sounding of the alarm or timer, the user needs to light up a display screen of his electronic device, and then check the clock on the electronic device. Thus the operation is relatively complicated. Furthermore, it may be inconvenient for the user to check the mobile phone, so that the user cannot know about the remaining time duration of the alarm or timer conveniently and timely.

### BRIEF SUMMARY

In summary, one aspect provides a method, comprising: determining a first bending angle of a flexible body of an electronic device; deriving a timing duration in accordance with the first bending angle of the flexible body; controlling the first bending angle of the flexible body until the first bending angle of the flexible body gradually becomes a target bending angle at the end of the timing duration; and providing an alert upon the first bending angle of the flexible body becoming the target bending angle at the end of the timing duration.

Another aspect provides an electronic device, comprising a processor; a display device; a flexible body; an alerting device; and a memory device comprising instructions executable by the processor to: determine a first bending angle of the flexible body to derive a timing duration in accordance with a first bending angle of the flexible body; control the first bending angle of the flexible body dependent upon the timing duration until the first bending angle of the flexible body gradually becomes a target bending angle at the end of the timing duration; and activating the alerting device to provide an alert.

A further aspect provides a product, comprising: a storage device having code stored therewith, the code being executable by a processor and comprising: code that determines a first bending angle of a flexible body of an electronic device; code that derives a timing duration in accordance with the first bending angle of the flexible body; code that controls the first bending angle of the flexible body until the first bending angle of the flexible body gradually becomes a target bending angle at the end of the timing duration; and code that provides an alert upon the first bending angle of the flexible body becoming the target bending angle at the end of the timing duration.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 shows a schematic flow diagram of an embodiment of a reminding control method;

FIG. 2 shows a schematic flow diagram of another embodiment of a reminding control method;

FIG. 3 shows a schematic flow diagram of another embodiment of a reminding control method;

FIG. 4 shows a schematic structural diagram of an embodiment of a reminding control device; and

FIG. 5 shows a schematic structural diagram of another embodiment of a reminding control device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Embodiments of the present application provide a reminding control method and device which can control a bent (e.g., a bending angle) of an electronic device (e.g., a display screen of the electronic device) based on a target duration between a current moment and a set reminding moment such that a user can obtain a duration from the current moment to the set reminding moment intuitively.

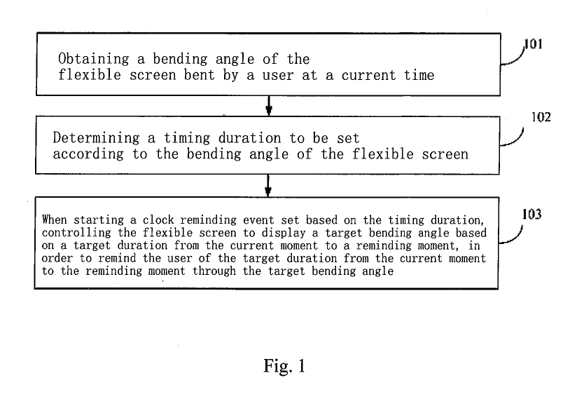

First, a reminding control method in accordance with an embodiment is described. Referring to FIG. 1, a schematic flow diagram of an embodiment of a reminding control method is shown. The method of the embodiment may be applied to an electronic device having a flexible display screen. The method may comprise:

Step 101: obtaining a bending angle of the flexible screen bent by a user at a current moment; and

Step 102: determining a timing duration to be set according to the bending angle of the flexible screen.

In the embodiment, the timing duration to be set is related to the bending angle of the flexible screen. When the bending angle of the flexible screen is different, the timing duration also may be different. As the timing duration is determined based on the bending angle of the flexible screen, an operation that a user sets the timing duration may be simplified, and thereby the convenience for setting the timing duration is improved.

At Step 103, when a clock reminding event set according to the timing duration is started, the flexible screen is controlled to present a target bending angle according to a target duration from the current moment to a reminding moment to prompt a user of the target duration from the current moment to the reminding moment through the target bending angle.

The clock reminding event is set according to the timing duration, and the reminding event is related to a clock. For example, the clock reminding event may be a timing duration or an alarm event, or an alert in general. The reminding moment is a moment when the clock reminding event is triggered to output an alarm or an alert. With a change of the duration from the current moment to the reminding moment, the target bending angle presented by the flexible screen controlled by a device will change accordingly such that a user may gauge an elapse of time by observing the change of the angle of the flexible screen and obtain the duration to the reminding moment.

For example, as the target duration from the current moment to the reminding moment becomes shorter progressively, the bending angle of the flexible screen may be controlled to become smaller progressively. When the current moment is the reminding moment, the bending angle of the flexible screen may be zero, so that a user may feel intuitively that the reminding moment gets closer by observing continuous reduction of the bending angle of the flexible screen and can pre-estimate the duration from the current moment to the reminding moment.

Preferably, in an embodiment, the timing duration to be set is determined based on the bending angle of the flexible screen bent by a user; after the clock reminding event set according to the timing duration is started, the bending angle of the flexible screen is controlled according to the duration from the current moment to the clock reminding moment, so that a user may know the remaining duration from the current moment to the clock reminding moment according to the bending angle of the flexible screen, and a user does not need to look up the corresponding interface of the electronic device but can conveniently obtain the remaining duration of the clock reminding event.

It should be understood that multiple ways may be used for obtaining the bending angle of the flexible screen bent by a user at the current moment. In an embodiment, an angle sensor may be arranged on the flexible screen. Then the bending degree of the flexible screen may be sensed by the angle sensor.

In another embodiment, a pressure sensor may be arranged on the flexible screen. Then the bending angle of the flexible screen may be determined according to the pressure values at different position points on the flexible screen. For example, the pressure distribution of different points on the flexible screen may be tested when the flexible screen is in different bending angles, thus establishing the corresponding relations among the pressure values of different points on the flexible screen and the bending angles. For example, when the bending degree of the flexible screen is relatively small, the pressures of the points located on the bending line of the flexible screen are relatively small. While the pressure values of the points out of the bending line are smaller than the pressure values of the points on the bending line, along with the increase of bending degree of the flexible screen, namely the bending angle of the flexible screen is increased, the pressure values of the points located on the bending line of the flexible screen are gradually increased. While the pressure values of the location points out of the bending line of the flexible screen are also increased, the variation is smaller than that of the pressure value of the bending line. When the flexible screen is folded in half at the bending line, the pressure value on the bending line is maximum, and the pressure of other positions produced by stretching also reaches the maximum value. Based on the case, the bending angles of the flexible screen corresponding to the distribution of different pressure values may be preset.

It should be understood that, in any of the above embodiments, a to-be-reminded event set according to the timing duration may also be determined after the timing duration to be set is determined.

In an embodiment, the target moment starting from the current moment and achieved after the timing duration to be set may also be determined after the timing duration to be set is determined. The clock reminding event which outputs an alert at the target moment is set. This implementation way is applicable to alarm clock reminding, for example, if the timing duration is 20 minutes and the current moment is 8:00, then the moment starting from the current moment and achieved after 20 minutes will be 8:20 so as to set the clock reminding event reminder at 8:20.

In another embodiment, after the timing duration to be set is determined, it also comprises: setting the timing duration to be set as the timing duration of the clock reminding event. For example, the timing duration to be set is determined as 20 minutes, the clock reminding event is an event to be reminded after a timing duration of 10 minutes; in this way, the timing is started after the clock reminding event is started; during the timing process, along with the increase of the clocking duration, the bending angle of the flexible screen is constantly increased or reduced until the timing duration lasts for 10 minutes, then the bending of the flexible screen is stopped, and the alert is provided.

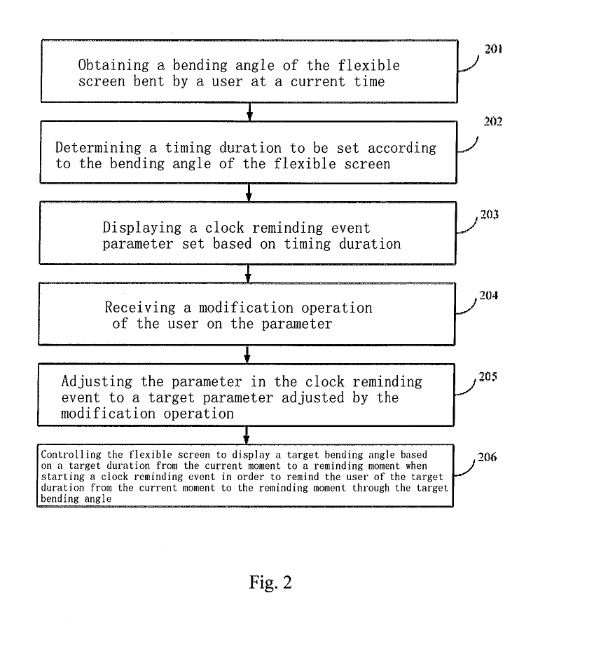

Referring to FIG. 2, a schematic flow diagram of an embodiment of a reminding control method is shown; the method of this embodiment may be applied to an electronic device, wherein the display screen of the electronic device is a flexible screen, the method may comprise:

Step 201: obtaining the bending angle of the flexible screen bent by a user at a current moment; and

Step 202: determining the timing duration to be set according to the bending angle of the flexible screen.

Steps 201 and 202 can be referred to the relevant descriptions of previous embodiments and are not described in more detail herein.

At Step 203, the parameter of the clock reminding event set according to the timing duration is displayed.

The parameter preferably includes the timing duration or the reminding moment. The parameter may include the specific classes or the relevant information, e.g., promoting the clock reminding event as a clocking event or an alarm clock, etc.

At Step 204, the parameter modification operation made by the user is received.

In an embodiment, after determining the timing duration, the parameter of the clock reminding event set based on the timing duration can also be displayed. Thus if a user thinks that the parameter of the clock reminding event is different from the parameter that the user actually needs, then the user may modify the parameter, for example, modifying the duration, the reminding moment, or the type of the clock reminding event.

At Step 205, the parameter of the clock reminding event is adjusted as the target parameter which is adjusted by the modification operation.

The adjusted parameter is preferably determined as the target parameter of the clock reminding event, and the specific content of the clock reminding event may be determined.

At Step 206, when a clock reminding event is started, the target bending angle that the flexible screen presents according to the target duration from the current moment to the reminding moment is controlled, in order to prompt the user of the target duration from the current moment to the reminding moment through the target bending angle.

In step 206, the started clock reminding event may be interpreted as the clock reminding event after the user adjusts the parameter.

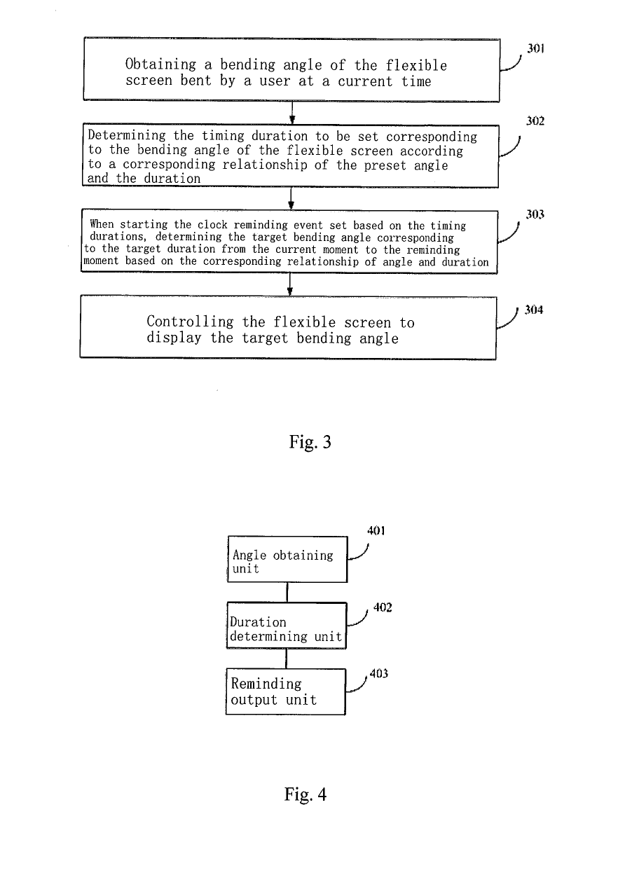

Referring to FIG. 3, a schematic flow diagram of an embodiment of a reminding control method is shown; and the method of this embodiment may be applied to an electronic device having a flexible display screen, the method may comprise:

Step 301: obtaining the bending angle of the flexible screen bent by a user at a current time; and

Step 302: determining the timing duration to be set corresponding to the bending angle of the flexible screen according to the corresponding relationship between the preset angle and the duration.

The relation between the angle and the duration may include either of two conditions as follows: one condition is that a one-to-one corresponding relationship is formed between the bending angle and the duration to be set so as to determine the duration to be set according to the bending angle, and the bending angle bent by a user is required to be accurately determined in this way, thus determining the corresponding timing duration. The other condition is that a corresponding relationship is formed between the angle range and the duration to be set. In this case, if the angle range of the flexible display screen is obtained, the timing duration to be set corresponding to the angle range may be determined according to the corresponding relationship; the angle range that the bending angle belongs to may be determined first, then the timing duration corresponding to the angle range may be determined.

At Step 303, determining the target bending angle corresponding to the target duration from the current moment to the reminding moment according to the corresponding relationship between the angle and the duration when the clock reminding event set according to the timing duration is started.

The reminding moment is a moment when the clock reminding event is triggered to output reminding. After starting the clock reminding event, a target bending angle to be presented by the flexible screen to be controlled can also be determined according to the corresponding relationship of angle and duration mentioned above, so that the corresponding relationship referred by the user when setting the timing duration is the same as the corresponding relationship of the target duration and the target bending angle after starting the clock reminding event.

At Step 304, the flexible screen is controlled to present the target bending angle.

It can be understood that, in any embodiment, since it is a continuous process that the user sets the timing duration and starts the clock reminding event set based on the timing duration, after the flexible screen is bent by the user, the bending angle of the flexible screen can be kept unchanged. After starting the clock reminding event, based on the target duration from the current moment to the reminding moment and the currently presented bending angle of the flexible screen, the bending angle of the flexible screen can be gradually decreased until arriving at the reminding moment, and then the bending angle of the flexible screen is changed to zero.

Optionally, in any embodiment of the present application, obtaining a bending angle of the flexible screen bent by a user at a current moment, the steps can be specifically as follows. When detecting a preset operation used for setting clock reminding, obtain the bending angle of the flexible screen bent by the user at the current moment. After detecting the preset operation, the bending angle of the flexible screen bent by the user is obtained to help to reduce misjudgment of the electronic device and avoid wrong operations.

An additional embodiment provides a reminding control device corresponding to a reminding control method.

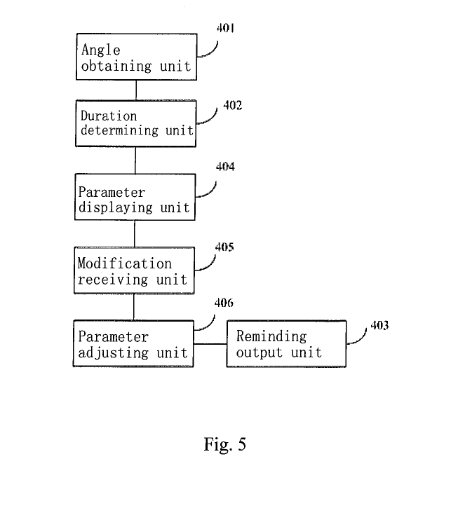

Referring to FIG. 4, a schematic diagram of an embodiment of a reminding control device is shown. The device in the embodiment is applied to an electronic device having a flexible display screen, and the device comprises: an angle obtaining unit 401 for obtaining a bending angle of the flexible screen bent by a user at a current moment; a duration determining unit 402 for determining a timing duration to be set according to the bending angle of the flexible screen; and a reminding output unit 403 for controlling flexible screen to present target bending angle based on a target duration from the current moment to a reminding moment when starting a clock reminding event set based on the timing duration, in order to prompt the user of the target duration from the current moment to the reminding moment through the target bending angle, wherein the reminding moment is a moment when the clock reminding event is triggered to output reminding.

In an embodiment, based on the bending angle of the flexible screen bent by the user, the timing duration to be set is determined, after starting the clock reminding event set based on the timing duration, according to the duration from the current moment to the clock reminding moment, the bending angle of the flexible screen can be controlled, so that according to the bending angle of the flexible screen, a user can know the remaining duration from the current moment to the reminding moment, and then, a user does not need to look up a corresponding interface of the electronic device, and can conveniently obtain the remaining duration of the clock reminding event.

Optionally, an embodiment may further comprise: a time tracking unit for determining a target moment started from the current moment and achieved after the timing duration to be set after the duration determining unit determines the timing duration to be set; and a reminding setting unit for setting the clock reminding event which outputs reminding at the target moment.

Optionally, an embodiment may further comprise: a timing setting unit for setting the timing duration to be set as the timing duration of the clock reminding event after the timing duration to be set is determined by the duration determining unit.

Referring to FIG. 5, shown is a schematic diagram of an embodiment of a reminding control device. This embodiment is applied to an electronic device having a flexible display screen. This embodiment is distinguished from the previous embodiments in that: the embodiment also comprises: a parameter display unit 404 for displaying the parameter of the clock reminding event set based on the timing duration after the duration determining unit determines the timing duration to be set, wherein the parameter comprises the timing duration or the reminding moment; a modification receiving unit 405 for receiving the parameter modification operation of the user; and a parameter adjusting unit 406 for adjusting the parameter of the clock reminding event into the target parameter after the modification operation.

Optionally, in an embodiment the duration determining unit can comprise: a duration determination subunit for determining the timing duration to be set corresponding to the bending angle of the flexible screen, according to the corresponding relationship between the preset angle and the duration. The reminding output unit comprises: an output angle determining unit for determining the target bending angle corresponding to the target timing duration from the current moment to the reminding moment based on the corresponding relationship between the angle and the duration when the clock reminding event set based on the timing duration is started; and an angle presentation control unit for controlling the flexible screen to present the target bending angle.

Optionally, in an embodiment, the angle obtaining unit can comprise: an angle obtaining subunit for obtaining the bending angle at which the flexible screen is bent by the user at the current moment when a preset operation of setting clock reminding is detected.

It should be noted that various embodiments are all described in a progressive way, with an emphasis of each embodiment on the differences from other embodiments, and the same and similar parts among the embodiments can be seen from cross references. For the system type embodiments, which are basically similar to the method embodiments, and are thus described in a relatively simple way, for the relevant parts, please refer to the partial descriptions of the method embodiments.

Finally, also it should be specified, such relational terms as the “first” and “second” are used solely to distinguish one entity or operation from another entity or operation, without necessarily requiring or implying that any of the actual relations or orders exists among such entities or operations. Furthermore, the terms “comprises,” “comprising” or any other variation thereof, are intended to cover a non-exclusive inclusion, such that a process, a method, an article, or a device which comprise a series of elements not only comprise the elements but also comprise other elements which are not expressly listed or comprise inherent elements of the process, the method, the article, or the device. An element defined by “comprises . . . a” does not, without more constraints, preclude the existence of additional identical elements in the process, the method, the article, or the device that comprise the elements.

Those skilled in the art should understand that, embodiments may be provided as methods, systems or computer program products. Therefore, embodiments may be in the form of hardware embodiments, software embodiments, or embodiments combining software and hardware aspects. Meanwhile, embodiments may be in the form of computer program products implemented on one or more computer usable storage media (including but not limited to magnetic disk memories, optical memories, etc.) containing computer usable program codes. In the context of this document, a storage media is not a signal and “non-transitory” includes all media except signal media.

Embodiments are described with reference to the flowcharts and/or block diagrams of the methods, devices (systems) and computer program products according to embodiments. It should be understood that each flow and/or block in a flowchart and/or a block diagram and a combination of flows and/or blocks in a flowchart and/or block diagram may be implemented by computer program instructions. These computer program instructions may be provided to a processor of a general purpose computer, a special purpose computer, an embedded processing machine or other programmable data processing equipment to generate a machine, such that a device for implementing functions specified in one flow or more flows in a flowchart and/or one block or more blocks in a block diagram is generated through instructions executed by the processor of a computer or other programmable data processing equipment.

These computer program instructions may also be stored in a computer readable memory capable of guiding a computer or other programmable data processing equipment to operate in a particular mode, such that the instructions stored in the computer readable memory generate a product including an instruction device. The instruction device implements functions specified in one flow or more flows in a flowchart and/or one block or more blocks in a block diagram.

These computer program instructions may also be loaded onto a computer or other programmable data processing equipment, such that a series of operation steps are executed on the computer or other programmable data processing equipment to generate a processing implemented by the computer. As such, the instructions executed on the computer or other programmable equipment provide steps for implementing the functions specified in one flow or more flows in a flowchart and/or one block or more blocks in a block diagram.

In the context of this document, a storage medium is not a signal and “non-transitory” includes all media except signal media.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
determining a first bending angle of a flexible body of an electronic device;
deriving a timing duration in accordance with the first bending angle of the flexible body;
controlling the first bending angle of the flexible body until the first bending angle of the flexible body gradually becomes a target bending angle at the end of the timing duration; and
providing an alert upon the first bending angle of the flexible body becoming the target bending angle at the end of the timing duration.

2. The method of claim 1, further comprising:
determining a target moment starting at a current moment and which will be achieved at the conclusion of the derived timing duration; and
setting a clock reminding event which outputs reminding at the target moment.

3. The method of claim 2, wherein setting the clock reminding event comprises setting the clock reminding event to the conclusion of the derived timing duration.

4. The method of claim 2, further comprising:
displaying a parameter of the clock reminding event set based on the derived timing duration, wherein the parameter comprises the timing duration or the reminding moment;
receiving a modification operation of a user on the parameter; and
adjusting the parameter in the clock reminding event to a target parameter adjusted by the modification operation.

5. The method of claim 1, wherein determining a timing duration in accordance with the first bending angle of the flexible body, comprises:
controlling the first bending angle based on a duration from a current moment to a reminding moment.

6. The method of claim 5, wherein the controlling comprises reducing the first bending angle as time progresses.

7. The method of claim 1, wherein the flexible body comprises a flexible screen.

8. An electronic device, comprising:
a processor;
a display device;
a flexible body;
an alerting device; and
a memory device comprising instructions executable by the processor to:
determine a first bending angle of the flexible body to derive a timing duration in accordance with a first bending angle of the flexible body;
control the first bending angle of the flexible body dependent upon the timing duration until the first bending angle of the flexible body gradually becomes a target bending angle at the end of the timing duration; and
activating the alerting device to provide an alert.

9. The device of claim 7, further comprising:
a moment reckoning unit which determines a target moment started from a current moment and achieved after the timing duration to be set; and
a reminding setting unit which sets a clock reminding event and which outputs reminding at the target moment.

10. The device of claim 7, further comprising:
a timing setting unit for setting the derived timing duration.

11. The device of claim 8, further comprising:
a parameter display unit which displays a parameter of the clock reminding event set based on the determined timing duration, wherein the parameter comprises a parameter selected from the group consisting of the derived timing duration and the reminding moment;
a modification receiving unit which receives a modification operation of a user on the parameter; and
a parameter adjusting unit which adjusts the parameter in the clock reminding event to a target parameter adjusted by the modification operation.

12. The device of claim 7, further comprising:
a duration determining unit which determines a timing duration to be set according to a relationship between the first bending angle and the derived timing duration;
an output angle determining unit which determines a target bending angle; and
an angle presentation control unit which controls the first bending angle of the flexible body to achieve the target bending angle.

13. The device of claim 7, further comprising:
an angle obtaining unit which obtains a bending angle of a flexible screen bent by a user at a current moment when detecting a preset operation used for setting clock reminding.

14. A product, comprising:
a storage device having code stored therewith, the code being executable by a processor and comprising:
code that determines a first bending angle of a flexible body of an electronic device;
code that derives a timing duration in accordance with the first bending angle of the flexible body;
code that controls the first bending angle of the flexible body until the first bending angle of the flexible body gradually becomes a target bending angle at the end of the timing duration; and
code that provides an alert upon the first bending angle of the flexible body becoming the target bending angle at the end of the timing duration.

15. The product of claim 14, further comprising:
code that determines a target moment starting at a current moment and which will be achieved at the conclusion of the derived timing duration; and
code that sets a clock reminding event which outputs the alert at the target moment.

16. The product of claim 15, wherein the code that sets the clock reminding event comprises code that sets the clock reminding event to the conclusion of the derived timing duration.

17. The product of claim 15, further comprising:
code that displays a parameter of the clock reminding event set based on the derived timing duration, wherein the parameter comprises the timing duration or the reminding moment;
code that receives a modification operation of a user on the parameter; and
code that adjusts the parameter in the clock reminding event to a target parameter adjusted by the modification operation.

18. The product of claim 14, wherein the code that controls the first bending angle of the flexible body, comprises:
code that determines the timing duration to be set corresponding to a bending angle of a flexible screen according to a corresponding relationship between a present angle and the timing duration;
code that controls the flexible screen to present a target bending angle based on a target duration from a current moment to a reminding moment;
code that determines the target bending angle corresponding to the target duration from the current moment to the reminding moment; and
code that controls the flexible screen to achieve the target bending angle.

19. The product of claim 18, further comprising:
code that upon detecting a preset operation used for setting clock reminding, obtains a bending angle of the flexible screen bent by a user at the current moment.

20. The product of claim 14, further comprising:
code that displays a parameter of the clock reminding event set based on the derived timing duration, wherein the parameter comprises the timing duration or the reminding moment;
code that receives a modification operation of a user on the parameter; and
code that adjusts the parameter in the clock reminding event to a target parameter adjusted by the modification operation.
